(19) United States
(12) Patent Application Publication
(10) Pub. No.: US 2014/0075575 A1
(43) Pub. Date: Mar. 13, 2014

(54) CONTENT DELIVERY SYSTEM WITH AN IDENTIFICATION MECHANISM AND METHOD OF OPERATION THEREOF

(71) Applicants: Esther Jun Kim, San Jose, CA (US); Michael Kuniavsky, San Francisco, CA (US); Stacie Hibino, San Jose, CA (US)

(72) Inventors: Esther Jun Kim, San Jose, CA (US); Michael Kuniavsky, San Francisco, CA (US); Stacie Hibino, San Jose, CA (US)

(73) Assignee: Samsung Electronics Co., Ltd., Gyeonggi-Do (KR)

(21) Appl. No.: 13/607,279

(22) Filed: Sep. 7, 2012

(51) Int. Cl. G06F 21/24; G06F 15/16

(52) U.S. Cl. 726/29

(57) ABSTRACT

A method of operation of a content delivery system includes: compiling a detected device ensemble; detecting user information to develop a profile; and retrieving a content with an access level matching the profile and compatible with the detected device ensemble for displaying on a device.

### TECHNICAL FIELD

The present invention relates generally to a content delivery system, and more particularly to a system for delivering individualized content.

### BACKGROUND ART

Modern portable consumer and industrial electronics, especially client devices such as navigation systems, cellular phones, portable digital assistants, and combination devices, are providing increasing levels of functionality to support modern life including personalized content services. Research and development in the existing technologies can take a myriad of different directions.

As users become more empowered with the growth of personalized content service devices, new and old paradigms begin to take advantage of this new device space. There are many technological solutions to take advantage of this new device location opportunity. One existing approach is to evaluate user profile and location information to provide personalized content through a mobile device such as a cell phone, a smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Content delivery system and personalized content services enabled systems have been incorporated in automobiles, notebooks, handheld devices, and other portable products. Today, these systems aid users by incorporating available, real-time relevant information, such as advertisement, entertainment, local businesses, or other points of interest (POI).

However market pressures and competitive demands reveal inadequate effectiveness providing relevant, useable, and customized content. These pressures further highlight an alarming privacy and security concerns with current content delivery systems.

Thus, a need still remains for a content delivery system with an identification mechanism to provide seamless, effective, relevant, useable and secure content. In view of the current market pressures and competitive demands, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a content delivery system including: compiling a detected device ensemble; detecting user information to develop a profile; and retrieving a content with an access level matching the profile and compatible with the detected device ensemble for displaying on a device.

The present invention provides a content delivery system, including: a device engine module for compiling a detected device ensemble; an identification engine module, coupled to the device engine module, for detecting user information to develop a profile; and a content engine module, coupled to the device engine module, for retrieving a content with an access level matching the profile and compatible with the detected device ensemble.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a content delivery system with an identification mechanism in an embodiment of the present invention.

FIG. 2 is a display interface of the first device.

FIG. 3 is an exemplary hardware block diagram of the content delivery system of FIG. 1.

FIG. 4 is an exemplary block diagram of the content delivery system of FIG. 1.

FIG. 5 is a control flow of the content delivery system for identification.

FIG. 6 is a control flow of the content delivery system for profile generation.

FIG. 7 is a control flow of the content delivery system for access assessment.

FIG. 8 is a control flow of the content delivery system for customization.

FIG. 9 is a control flow of the content delivery system for ensemble generation.

FIG. 10 is a control flow of the content delivery system for capability combining.

FIG. 11 is a security model of the content of FIG. 2.

FIG. 12 is a customization map of the content of FIG. 2.

FIG. 13 is a flow chart of a method of operation of a content delivery system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it will be apparent that the invention can be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. Where multiple embodiments are disclosed and described having some features in common for clarity and ease of illustration, description, and comprehension thereof similar and like features one to another will ordinarily be described with similar reference numerals.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software operates on a physical hardware device and can be machine code, firmware, embedded code, and application software. Also for example, the hardware can be circuitry, processor, computer, integrated circuit, integrated circuit cores, a pressure sensor, an inertial sensor, a micro-electromechanical system, passive devices, or a combination thereof.

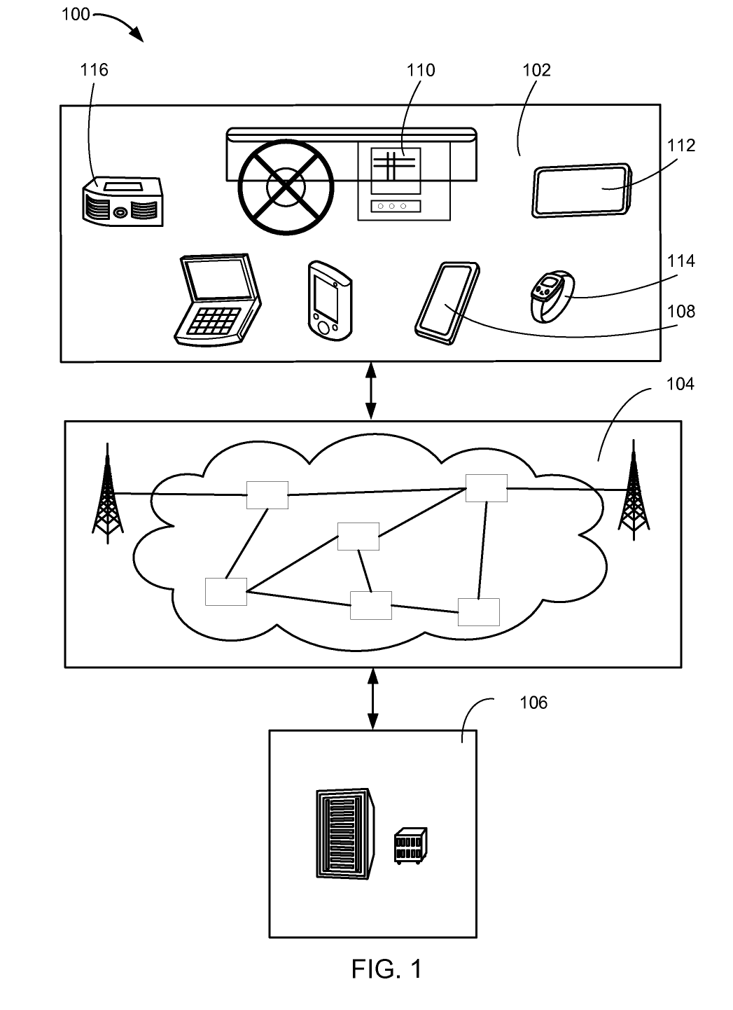

Referring now to FIG. 1, therein is shown a content delivery system 100 with an identification mechanism in an embodiment of the present invention. The content delivery system 100 includes a first device 102, such as a client or a server, connected to second devices 106, such as a client or servers, with a communication path 104, such as a wireless or wired network.

For example, the first device 102 can be of any of a variety of portable or stationary devices, such as a cellular phone 108, personal digital assistant, a notebook computer, an automotive content delivery system 110, a television 112, a smart watch 114, a wireless speaker 116, or other multi-functional mobile communication or entertainment device. The first device 102 can be a standalone device, or can be incorporated with a vehicle, for example a car, truck, bus, or train. The first device 102 can couple to the communication path 104 to communicate with the second devices 106 using wireless or wired communication paths. Coupling is defined as a physical connection.

For illustrative purposes, the content delivery system 100 is described with the first device 102 as a mobile computing device, although it is understood that the first device 102 can be different types of computing devices. For example, the first device 102 can also be a non-mobile computing device, such as a server, a server farm, or a desktop computer.

For illustrative purposes, the content delivery system 100 is described with the second devices 106 as server farms or cluster can be any of a variety of centralized or decentralized computing devices. For example, the second devices 106 can be computers, grid computing resources, virtualized computer resources, cloud computing resources, routers, switches, peer-to-peer distributed computing devices, or a combination thereof.

The second devices 106 can be centralized in a single computer room, distributed across different rooms, distributed across different geographical locations, and/or embedded within a telecommunications network. The second devices 106 can have a means for coupling with the communication path 104 to communicate with the first device 102. The second devices 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second devices 106 can be particularized machines, such as portable computing devices, thin clients, notebooks, netbooks, smartphones, personal digital assistants, or cellular phones, and as specific examples, an Apple iPhone™, Palm Centro™, Samsung Galaxy™, or Moto Q Global™.

For illustrative purposes, the content delivery system 100 is described with the second devices 106 as non-mobile computing devices, although it is understood that the second devices 106 can be different types of computing devices. For example, the second devices 106 can also be mobile computing devices, such as notebook computers, or different types of client devices. The second devices 106 can be standalone devices, or can be incorporated with a vehicle, for example a car, truck, bus, or train.

Also for illustrative purposes, the content delivery system 100 is shown with the second devices 106 and the first device 102 as end points of the communication path 104, although it is understood that the content delivery system 100 can have a different partition between the first device 102, the second devices 106, and the communication path 104. For example, the first device 102, the second devices 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

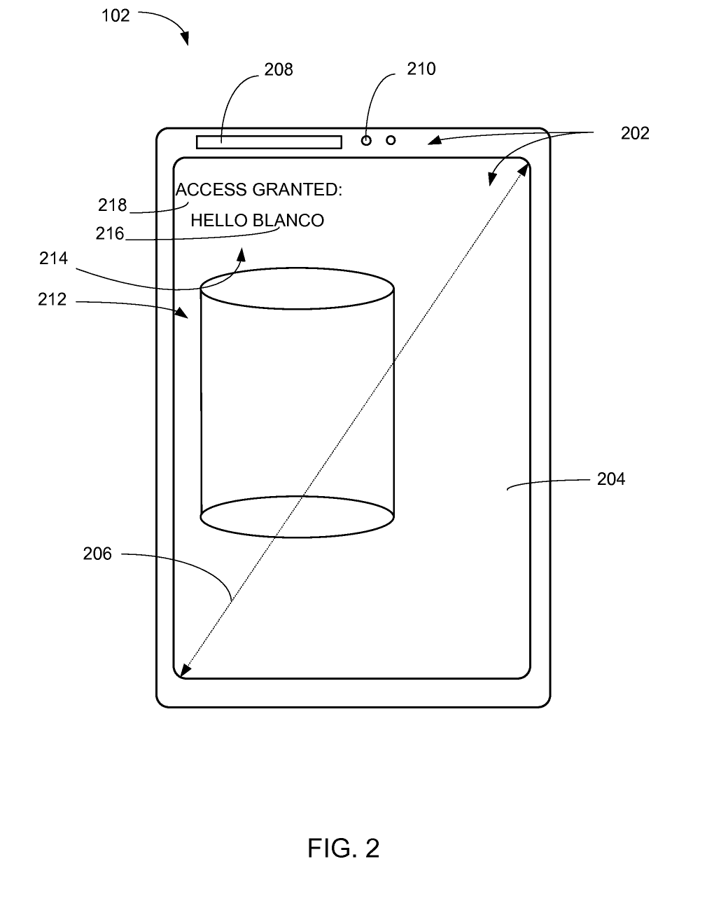

Referring now to FIG. 2, therein is shown a display interface of the first device 102 of FIG. 1. The first device 102 can have a first device ensemble 202. The first device ensemble 202 is defined as the physical hardware capabilities of the first device 102. The first device ensemble 202 can include a display 204 with a size 206, a speaker 208 rated for a power rating, and a forward facing camera 210.

The display 204 can display content 212 and can display device attributes 214. The device attributes 214 are defined as the settings of the first device 102 or the second devices 106 of FIG. 1. The device attributes 214 can include a device ownership 216 (individuals, groups, or public), the restrictions to access 218 of the first device 102, user preferences of the first device 102, factory settings of the first device 102, or a combination thereof.

The content 212 is shown as a visual representation, although it is understood that the content 212 can be presented with any visual, audible, or tactile methods. For example, the content 212 can be presented with text, images, audio, video, graphics, vibration, or a combination thereof.

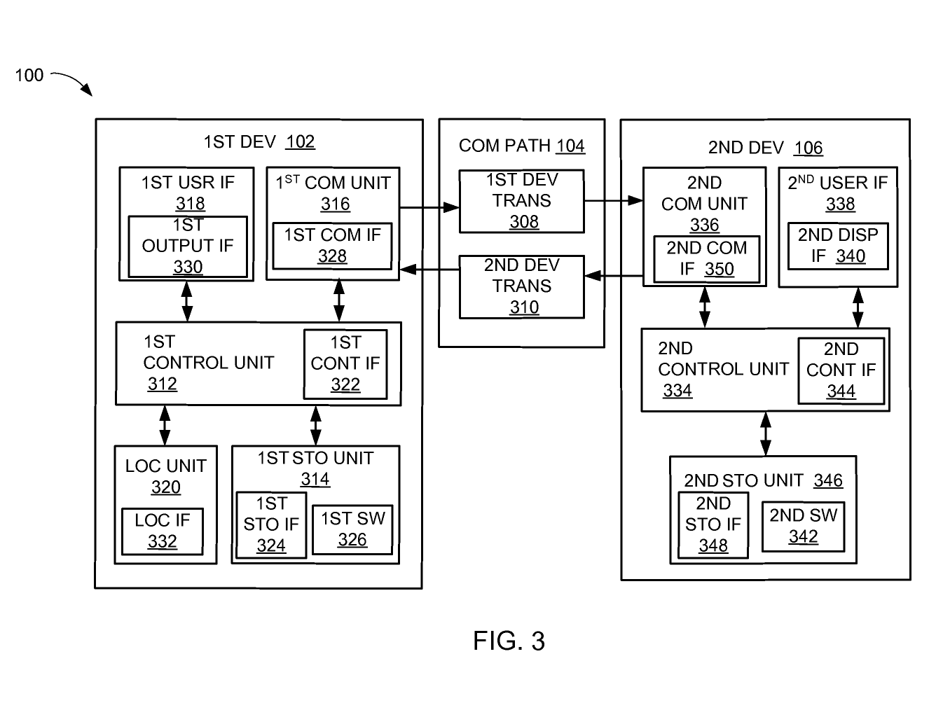

Referring now to FIG. 3, therein is shown an exemplary hardware block diagram of the content delivery system 100. The content delivery system 100 can include the first device 102, the communication path 104, and the second devices 106. The first device 102 can send information in a first device transmission 308 over the communication path 104 to the second devices 106 for broadcasting or streaming data. The second devices 106 can send information in a second devices transmission 310 over the communication path 104 to the first device 102 for broadcasting or streaming data.

For illustrative purposes, the content delivery system 100 is shown with the first device 102 as a client device, although it is understood that the content delivery system 100 can have the first device 102 as a different type of device. For example, the first device 102 can be a server.

Also for illustrative purposes, the content delivery system 100 is shown with the second devices 106 as servers, although it is understood that the content delivery system 100 can have the second devices 106 as different types of devices. For example, the second devices 106 can be client devices. The present invention is not limited to this selection for the type of devices. The selection is an example of the present invention.

The first device 102 can include a first control unit 312, a first storage unit 314, a first communication unit 316, a first user interface 318, and a location unit 320. The first control unit 312 can include a first control interface 322. The first control unit 312 can execute a first software 326 to provide the intelligence of the content delivery system 100. The first control unit 312 can be implemented in a number of different manners. For example, the first control unit 312 can be a processor, an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations physically separate from the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The location unit 320 can generate location information, current heading, and current speed of the first device 102, as examples. The location unit 320 can be implemented in many ways. For example, the location unit 320 can function as at least a part of a global positioning system (GPS), an inertial navigation system, a cellular-tower location system, a pressure location system, or any combination thereof.

The location unit 320 can include a location interface 332. The location interface 332 can be used for communication between the location unit 320 and other functional units in the first device 102. The location interface 332 can also be used for communication that is external to the first device 102.

The location interface 332 can receive information from the other functional units or from external sources, or can transmit information to the other functional units or to external destinations. The external sources and the external destinations refer to sources and destinations physically separate from the first device 102.

The location interface 332 can include different implementations depending on which functional units or external units are being interfaced with the location unit 320. The location interface 332 can be implemented with technologies and techniques similar to the implementation of the first control interface 322.

The first storage unit 314 can store the first software 326. The first storage unit 314 can also store the relevant information, such as personal media, documents, advertisements, points of interest (POI), navigation routing entries, or any combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between the location unit 320 and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations physically separate from the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second devices 106, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, or any combination thereof to provide data and communication inputs.

The first user interface 318 can include a first output interface 330. The first output interface 330 can include a display, a projector, a video screen, a speaker, or any combination thereof.

The first control unit 312 can operate the first user interface 318 to display information generated by the content delivery system 100. The first control unit 312 can also execute the first software 326 for the other functions of the content delivery system 100, including receiving location information from the location unit 320. The first control unit 312 can further execute the first software 326 for interaction with the communication path 104 via the first communication unit 316.

The second devices 106 can be optimized for implementing the present invention in a multiple device embodiment with the first device 102. The second devices 106 can provide the additional or higher performance processing power compared to the first device 102. The second devices 106 can include a second control unit 334, a second communication unit 336, and a second user interface 338.

The second user interface 338 allows a user (not shown) to interface and interact with the second devices 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second devices 106 of the content delivery system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the content delivery system 100, including operating the second communication unit 336 to communicate with the first device 102 over the communication path 104.

The second control unit 334 can be implemented in a number of different manners. For example, the second control unit 334 can be a processor, an embedded processor, a microprocessor, a hardware control logic, a hardware finite state machine (FSM), a digital signal processor (DSP), or a combination thereof.

The second control unit 334 can include a second control interface 344. The second control interface 344 can be used for communication between the second control unit 334 and other functional units in the second devices 106. The second control interface 344 can also be used for communication that is external to the second devices 106.

The second control interface 344 can receive information from the other functional units or from external sources, or can transmit information to the other functional units or to external destinations. The external sources and the external destinations refer to sources and destinations physically separate from the second devices 106.

The second control interface 344 can be implemented in different ways and can include different implementations depending on which functional units or external units are being interfaced with the second control interface 344. For example, the second control interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the relevant information, such as personal media, documents, advertisements, points of interest (POI), navigation routing entries, or any combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the content delivery system 100 is shown with the second storage unit 346 as a single hierarchy storage system, although it is understood that the content delivery system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between the location unit 320 and other functional units in the second devices 106. The second storage interface 348 can also be used for communication that is external to the second devices 106.

The second storage interface 348 can receive information from the other functional units or from external sources, or can transmit information to the other functional units or to external destinations. The external sources and the external destinations refer to sources and destinations physically separate from the second devices 106.

The second storage interface 348 can include different implementations depending on which functional units or external units are being interfaced with the second storage unit 346. The second storage interface 348 can be implemented with technologies and techniques similar to the implementation of the second control interface 344.

The second communication unit 336 can enable external communication to and from the second devices 106. For example, the second communication unit 336 can permit the second devices 106 to communicate with the first device 102 over the communication path 104.

The second communication unit 336 can also function as a communication hub allowing the second devices 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second devices 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second control interface 344.

The first communication unit 316 can couple with the communication path 104 to send information to the second devices 106 in the first device transmission 308. The second devices 106 can receive information in the second communication unit 336 from the first device transmission 308 of the communication path 104.

The second communication unit 336 can couple with the communication path 104 to send information to the first device 102 in the second devices transmission 310. The first device 102 can receive information in the first communication unit 316 from the second devices transmission 310 of the communication path 104. The content delivery system 100 can be executed by the first control unit 312, the second control unit 334, or a combination thereof.

For illustrative purposes, the second devices 106 are shown with the partition having the second user interface 338, the second storage unit 346, the second control unit 334, and the second communication unit 336, although it is understood that the second devices 106 can have a different partition. For example, the second software 342 can be partitioned differently such that some or all of its function can be in the second control unit 334 and the second communication unit 336. Also, the second devices 106 can include other functional units not shown in FIG. 3 for clarity.

The functional units in the first device 102 can work individually and independently of the other functional units. The first device 102 can work individually and independently from the second devices 106 and the communication path 104.

The functional units in the second devices 106 can work individually and independently of the other functional units. The second devices 106 can work individually and independently from the first device 102 and the communication path 104.

For illustrative purposes, the content delivery system 100 is described by operation of the first device 102 and the second devices 106. It is understood that the first device 102 and the second devices 106 can operate any of the modules and functions of the content delivery system 100. For example, the first device 102 is described to operate the location unit 320, although it is understood that the second devices 106 can also operate the location unit 320.

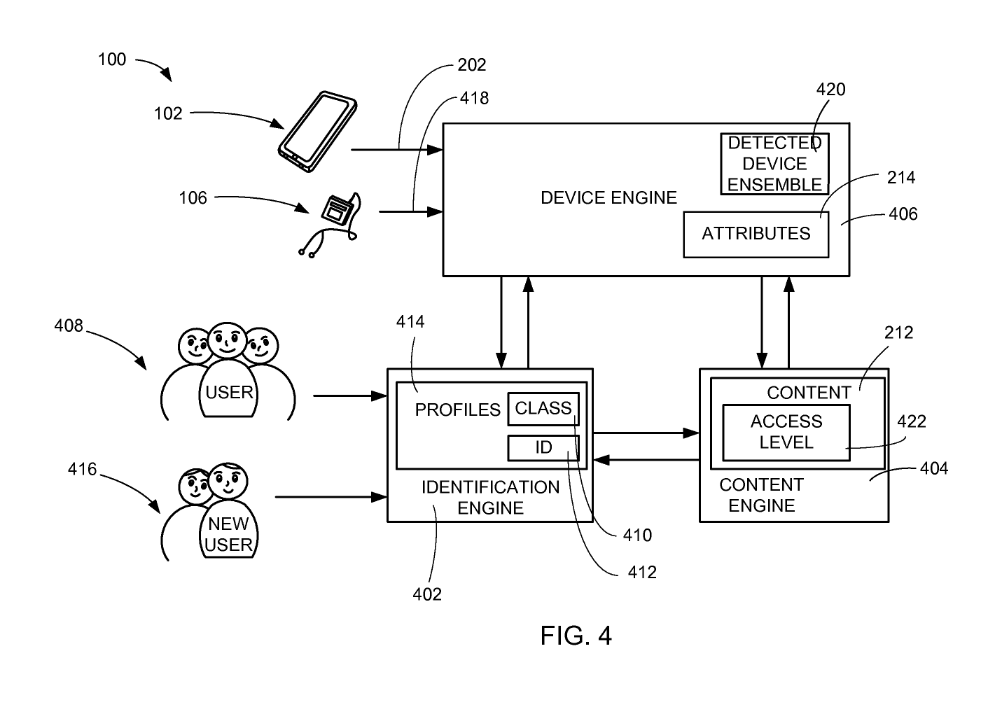

Referring now to FIG. 4, therein is shown an exemplary block diagram of the content delivery system 100. The content delivery system 100 is shown having an identification engine module 402 coupled to a content engine module 404 and coupled to a device engine module 406. The device engine module 406 can further be coupled to the content engine module 404.

The identification engine module 402 can sort users 408 imparting a user classification 410 or a user identification 412 that can be used to develop or form profiles 414 of the users 408 as described in greater detail below. An example of the profiles 414 can include parents, best friends, or colleagues.

The identification engine module 402 can further form the profiles 414 based on the number of the users 408 alone. The identification engine module 402 can detect whether any of the users 408 are present, whether a single or a few of the users 408 are present, or whether a larger group of the users 408 is present. The content engine module 404 can provide some of the content 212 based on whether any of the users 408 are present.

Access to the first device 102 can also be restricted until the users 408 have the profiles 414 that are properly authorized. As an example, if the first device 102 is restricted to only access by one of the users 408 having one of the profiles 414 of an owner, then the first device 102 will not function unless the users 408 have the user identification 412 corresponding to an owner. As a further example, if the first device 102 can be used by anyone and the users 408 the identification engine module 402 has not established the user identification 412 or the user classification 410 the first device 102 only provides access to default public information, delivered in a default customization view.

The identification engine module 402 can also detect when new users 416 enter the vicinity or one of the users 408 leaves the vicinity where detection is possible the first device 102 or the second devices 106. The identification engine module 402 can determine that the new users 416 shift the profiles 414 of the users 408 already present and modify the profiles 414 of the users 408 and the new users 416 interacting with the first device 102 described in detail below. The identification engine module 402 can function without the device engine module 406 and the content engine module 404 in situations where there is no assumption of multiple levels of access of the content 212.

The device engine module 406 coupled to the identification engine module 402 can also interface with the first device 102. The first device 102, and is depicted similarly to the cellular phone 108 of FIG. 1, but is not limited to the cellular phone 108. The device engine module 406 can request the profiles 414 of the identification engine module 402.

The device engine module 406 can also detect the device attributes 214 of the first device 102. The device attributes 214 can include the device ownership 216 of FIG. 2 of the first device 102 (individuals, groups, or public), the restrictions to access of the first device 102, user preferences of the first device 102, and factory settings of the first device 102. As an example, the device engine module 406 can detect the device attributes 214 of the first device 102 as a possible ownership restriction on the first device 102 and limit the use of the first device 102 to when the identification engine module 402 indicates that the user identification 412 of one of the users 408 is an owner.

The device engine module 406 can also interface with the second devices 106. The second devices 106 are depicted as personal music players but are not so limited. The second devices 106 and the first device 102 can be carried by the users 408, the new users 416, or can be affixed in the environment.

The device engine module 406 can detect the first device ensemble 202 and the device attributes 214 of the first device 102 described in greater detail below. The device engine module 406 can also detect a second device ensemble 418 and the device attributes 214 of the second device 106 described in greater detail below.

By collecting the first device ensemble 202 of the first device 102 and the second device ensemble 418 of the second devices 106 the device engine module 406 can combine the first device ensemble 202 and the second device ensemble 418 to create or compile a detected device ensemble 420. The detected device ensemble 420 can include the first device ensemble 202, the second device ensemble 418, or any combination.

The content engine module 404 can be coupled both to the identification engine module 402 and to the device engine module 406. The content engine module 404 can request and receive the profiles 414 from the identification engine module 402. The content engine module 404 can also request and receive the detected device ensemble 420 from the device engine module 406 to provide the content 212 displayable or compatible with the detected device ensemble 420. The content 212 is compatible or displayable with the detected device ensemble 420 if the content 212 is not restricted by the detected device ensemble 420, this can include, for example, having the speaker 208 of FIG. 2 with the proper range or the display 204 of FIG. 2 being large enough to reproduce and display the content 212.

The content engine module 404 can determine an access level 422 required to access the content 212 described in greater detail below. The content engine module 404 can also restrict access the content 212 based on the profiles 414. The access level 422 can be restricted to one of the profiles 414 or to the user identification 412 or the user classification 410 of the users 408. The content engine module 404 can also provide the content 212 when the access level 422 is overridden.

The content engine module 404 can retrieve the content 212 based on the user identification 412 or the user classification 410 with the access level 422 matching the profiles 414. The content engine module 404 can also retrieve the content 212 compatible with the first device ensemble 202, the second device ensemble 418, or the detected device ensemble 420. The content engine module 404 can also retrieve the content 212 transcoded for the first device ensemble 202, the second device ensemble 418, or the detected device ensemble 420.

As an example more of the content 212 can be accessible to the users 408 if the users 408 are uniquely identified with the user identification 412 rather than if the users 408 are not. As another example, the users 408 have the user classification 410 of “general public” the users 408 might only have access to the content 212 rated “G”, or generally published information that is available to everyone.

As a further illustrative example, if the users 408 have the user classification 410 of parents the users 408 can have one of the profiles 414 that permits mature content to be displayed on the first device 102. If the new users 416 that has the user classification 410 of a child enters the room, the identification engine module 402 can recognize that one of the new users 416 does not have the user classification 410 of “parent” and possibly does not allow for mature content. When the new users 416 does not have the profiles 414 or the user classification 410 allowing for mature content, the content engine module 404 can automatically pause the content 212 rated mature and prompt the users 408 whether they would like to continue with a visual or audio selection.

Another illustrative example can include the content 212 having the access level 422 “private”. When the content 212 access level 422 is “private” only the users 408 that are uniquely identified with the user identification 412 can view the content 212. When the new users 416 enter the vicinity, the identification engine module 402 can detect the new users 416 and if the new users 416 cannot be uniquely identified with the user identification 412, the content engine module 404 can stop or pause the display of the content 212 with the access level 422 “private”. The first device 102 can audibly notify that “Unauthorized Persons Detected”, include a visual display of a “Protected View”.

The content engine module 404 can prompt the users 408 on the second devices 106 whether to grant permission to the new users 416 by clicking on the surface of the second devices 106. If permission is granted, the first device 102 can again display the content 212 that is private and the users 408 can send the new users 416 a copy of the protected material, if it is appropriate, by indicating the transfer on the second devices 106 to provide seamless and secure sharing of information between the users 408 and the second devices 106 that are differently owned.

As another example, the content engine module 404 can provide protection to sensitive parts or personal parts of the content 212 by halting the display of a sensitive piece of the content 212 when one of the new users 416 enters and does not have one of the profiles 414 required for access. As an example, providing protection can be desirable for confidential documents in a business environment or personal health information displayed at home. As a further example, the content engine module 404 can change the display of the first device 102 to “party” mode if the users 408 are found to have a group size of more than five. Another example might include changing a suggested driving route displayed on the first device 102 if one of the users 408 has one of the profiles 414 indicating a proclivity for scenic driving routes.

The access level 422 can also be used to control the display of the content 212 to the users 408 not having the legal rights, in the form of ownership or licenses, to use the content 212. For example, the intellectual property rights of the content 212 can be open, transferrable, or temporary. The rights of the content 212 can also include ownership of a license to use, display, or reproduce copyrighted material. The content engine module 404 can restrict the use of the content 212 to only the users 408 with the profiles 414 meeting or exceeding the access level 422 of the content 212.

The content engine module 404 can prioritize the content 212 and present the content 212 in a customized way to each individual one of the users 408, based on the profiles 414 of the users 408, and present the content 212 in a customized way for the first device 102 or the second devices 106 described in greater detail below. The content engine module 404 can provide the content 212 for display to the first device 102 in a way that can utilize various capabilities of the first device 102 to enhance and perfect the experience and usability of the users 408.

The content 212 can include recommendations, preferences, subscriptions, data, media, and software. The content engine module 404 can provide the content 212 for display that both new and existing and is appropriate to the first device 102, for example, audio only if a display is not included with the device, or can provide the content 212 for display that will run the best with the applications that might be running on the first device 102, what content is already available on the first device 102, or based on the restrictions placed on the first device 102 by one of the users 408.

The content engine module 404 can provide and prioritize the content 212, while the identification engine module 402, and the device engine module 406 can collect information in a way that is perceptible to the users 408 or in a way that is imperceptible or in the background of a currently provided part of the content 212 described in greater detail below. The content 212 of the content engine module 404 can include copyrighted material, user-generated material (like photos, videos, or music), applications, personal data (like health records), and any other digitally-created medium. The content engine module 404 can also provide the content 212 contained on the first device 102 to the second devices 106 when authorized by the users 408 pursuant to the restrictions of the first device ensemble 202, the device attributes 214 of FIG. 2 of the second device 106, and the access level 422 of the users 408.

It has been discovered utilizing the content engine module 404 to request and receive the profiles 414 from the identification engine module 402 and request and receive the detected device ensemble 420 from the device engine module 406 enables providing access to the content 212 that is sensitive while maintaining security over the content 212 and still providing useable portions of the content 212.

It has been further discovered that utilizing the identification engine module 402 to impart the user classification 410 or the user identification 412 forming the profiles 414 of the users 408 is not restrained to utilizing specific information or devices.

For example in public places if the identification engine module 402 detects that the users 408 are teens then the first device 102 can display the content 212 that is teen oriented, while if the identification engine module 402 detects that the users 408 include several young children the first device 102 can display the content that is family oriented. Other illustrative examples of how the content delivery system 100 might operate include, if for instance, one of the users 408 purchases the first device 102, possibly the television 112 of FIG. 1 or the wireless speaker 116 of FIG. 1. The first device 102 can be turned on.

Once the device is turned on the device engine module 406 will collect the first device ensemble 202 of the first device 102. The device engine module 406 can then audibly or visually prompt the users 408 to decide whether the second devices 106, possibly the cellular phone 108, or the automotive content delivery system 110 of FIG. 1, for example, should be used to set up the first device 102. The device engine module 406 can also prompt the users 408 to decide whether the first device 102 should be connected to the second devices 106. The second devices 106 can be used to establish content restrictions, ownership restrictions, and ownership identification.

The first device 102 can display a model of the second devices 106 that were detected when the visual prompt is made. Further, a catalog of the users 408 preferences can be displayed graphically along with the ability to change the preferences for the first device 102 during set up. If the first device 102 utilizes audio notification it can provide verbal instructions and allow one of the users 408 to respond by pressing a button or tapping the first device 102. If confirmed, the first device 102 can give audio feedback that the second devices 106 have been connected.

It has been discovered that the device engine module 406 utilized to detect the device attributes 214, such as the ownership of the first device 102 (individuals, groups, or public), the restrictions to access of the first device 102, user preferences of the first device 102, and factory settings of the first device 102 provides enhanced out-of-box functionality and access to the content 212.

As an illustrative example, if one of the second devices 106 includes the automotive content delivery system 110 and the first device 102 is the wireless speaker 116, then one of the users 408 can be listening to the content 212 while driving and listening to the content 212 with the automotive content delivery system 110. The identification engine module 402 can detect that this one of the users 408 has exited and left the vicinity of the automotive content delivery system 110 and has entered the vicinity of the wireless speaker 116.

The content engine module 404 can pause or suspend the content 212 being provided for display to the automotive content delivery system 110 and resume the content on the wireless speaker 116. This pause and resume feature allows the content engine module 404 to seamlessly provide the content 212 through the first device 102 and the second devices 106 without any affirmative input from the users 408.

As another illustrative example, if the second devices 106 include the cellular phone 108 and the first device 102 is the television 112 the users 408 can use the second devices 106 to view the content 212 and provide the content 212 or a preview of the content 212 to the first device 102. The content 212 can be provided to the first device 102 can include pressing an indication portion of the second devices 106 screen or using a flicking gesture on the second devices 106 toward the first device 102.

The device engine module 406, the identification engine module 402, and the content engine module 404 can be operated on the first control unit 312 of FIG. 3 or the second control unit 334 of FIG. 3. The device engine module 406, the identification engine module 402, and the content engine module 404 can be coupled together through the communication path 104 of FIG. 3 or can be coupled internally to the first control unit 312 or the second control unit 334.

The device attributes 214 of the first device 102 or the second devices 106 can be information included in the first software 326 of FIG. 3 on the first storage unit 314 of FIG. 3 or the second software 342 of FIG. 3 on the second storage unit 346 of FIG. 3. The device engine module 406 can determine the device attributes 214 of the first device 102 and the second devices 106 by accessing the first software 326 through the first storage interface 324 of FIG. 3 or the second storage interface 348 thorough the second software 342 of FIG. 3.

The first device ensemble 202 determined by the device engine module 406 can be collected from and reside on the first storage unit 314 or the second storage unit 346. The identification engine module 402 can operate on the first control unit 312 or the second control unit 334 and can form the profiles 414 of the users 408 by monitoring the users 408 through the first user interface 318 of FIG. 3 or the location unit 320 of FIG. 3. Further, the identification engine module 402 can monitor the users 408 or the new users 416 through the second communication unit 336 of FIG. 3 to form the profiles 414.

The identification engine module 402 can monitor the users 408 or the new users 416 on either the first device 102 or the second devices 106 over the communication path 104. The content engine module 404 can operate on the first control unit 312 or the second control unit 334 and may operate on both. The content engine module 404 can access the content 212 stored on the first storage unit 314 or the second storage unit 346 and can access the content 212 over the communication path 104. The access level 422 of the content 212 can be stored with the content 212 or can be stored in the first storage unit 314 or the second storage unit 346 separately from the content 212.

The modules discussed above and below can be implemented in hardware. For example the modules can be implemented as hardware acceleration implementations in the first control unit 312, the second control unit 334, or a combination thereof. The modules can also be implemented as hardware implementations in the first device 102, the second devices 106, or a combination thereof outside of the first control unit 312 or the second control unit 334.

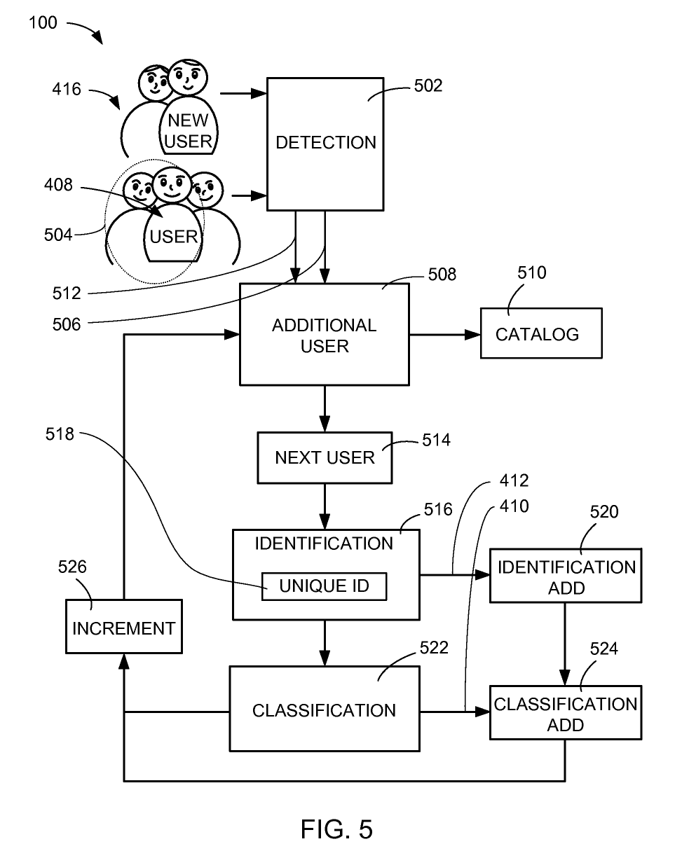

Referring now to FIG. 5, therein is shown a control flow of the content delivery system 100 for identification. The content delivery system 100 is shown having a detection module 502.

The detection module 502 can monitor the users 408. When the users 408 detected by the detection module 502 change in number the detection module 502 can indicate that a group 504 of the users 408 includes the new users 416. The detection module 502 can detect the new users 416 that enter or leave the environment or the area where detection is possible by the detection module 502.

The detection module 502 can further detect when the group 504 diminishes or loses some of the users 408. When the group 504 size changes the detection module 502 can output a modification signal 506. The modification signal 506 can be input into an additional user module 508 coupled to the detection module 502. The detection module 502 can also detect the users 408 that remain in the area.

The additional user module 508 can communicate with the detection module 502 to retrieve the modification signal 506 sent from the detection module 502. The additional user module 508 can be coupled to a catalog 510 listing the users 408 where detection is possible by the detection module 502. The catalog 510 can include the user identification 412 or the user classification 410 for the users 408.

When the detection module 502 detects that one of the new users 416 has entered the vicinity where detection is possible by the detection module 502, the detection module 502 can output the modification signal 506 to the additional user module 508. The additional user module 508 can gather or detect user information 512 from the detection module 502 about the new users 416 changing the group 504. A next user module 514 can be coupled to the additional user module 508 and can evaluate the user information 512 for each of the new users 416 one at a time.

The next user module 514 can be coupled to an identification module 516. The identification module 516 inspects the user information 512 to determine whether the user information 512 contains enough unique identifiers 518 to uniquely identify the new users 416 with the user identification 412. The unique identifiers 518 can include visible and audio traits of the new users 416 such as gait, speech characteristics, facial characteristics, skin tone, body type, and similar traits.

The identification module 516 can further determine if the user information 512 does not contain enough of the unique identifiers 518 to uniquely identify the new users 416 with the user identification 412. If the new users 416 can be uniquely identified then the identification module 516 outputs the user identification 412 to an identification add module 520. The identification add module 520 can associate or assign the user identification 412 to the new users 416 in the catalog 510.

If the new users 416 cannot be uniquely identified, the identification module 516 will output the unique identifiers 518 of the user information 512 to a classification module 522. The classification module 522 can inspect the user information 512 and ascertain whether the new users 416 can be classified. This classification can be dependent on the capabilities of the first device 102 of FIG. 1. The classification module 522 can utilize any ascertainable information by the detection module 502 to classify the new users 416 including the unique identifiers 518.

When the new users 416 can be classified the classification module 522 outputs the user classification 410 of the new users 416 to a classification add module 524 coupled to the classification module 522. As an example, the classifications can be female, male, adult, child, or teen. The classification module 522 can associate the user classification 410 to the new users 416 in the catalog 510. An increment module 526 can be coupled to the classification module 522 and to the classification add module 524. If the new users 416 can be classified or if the new users 416 cannot be classified the increment module 526 will increment a counter and signal the additional user module 508 to proceed to the next of the new users 416.

The detection module 502, the additional user module 508, the next user module 514, the catalog 510, and the identification module 516 can be operated on or be a portion of the identification engine module 402 of FIG. 4. The detection module 502 can detect the users 408 or the new users 416 and collect the user information 512 through the first user interface 318 of FIG. 3, the location unit 320 of FIG. 3, or the second communication unit 336 of FIG. 3. The detection module 502 can be operated on the first control unit 312 of FIG. 3 of the first device 102 or the second control unit 334 of FIG. 3 of the second devices 106.

The detection module 502 can monitor the users 408, collecting the user information 512, over the communication path 104 of FIG. 1 when monitoring both the first device 102 and the second devices 106. The additional user module 508 can operate on the first control unit 312 or the second control unit 334 and can incorporate the user information 512 and the modification signal 506 through the first control interface 322 of FIG. 3 or the second control interface 344 of FIG. 3. The next user module 514, the identification module 516, and the classification module can all be operated on the first control unit 312 or the second control unit 334.

The identification module 516 can store the unique identifiers 518 screened from the user information 512 on the first storage unit 314 of FIG. 3 or the second storage unit 346 of FIG. 3 for use in the content engine module 404. The catalog 510 can be stored and accessed from either the first storage unit 314 of the first device 102 or the second storage unit 346 of the second devices 106.

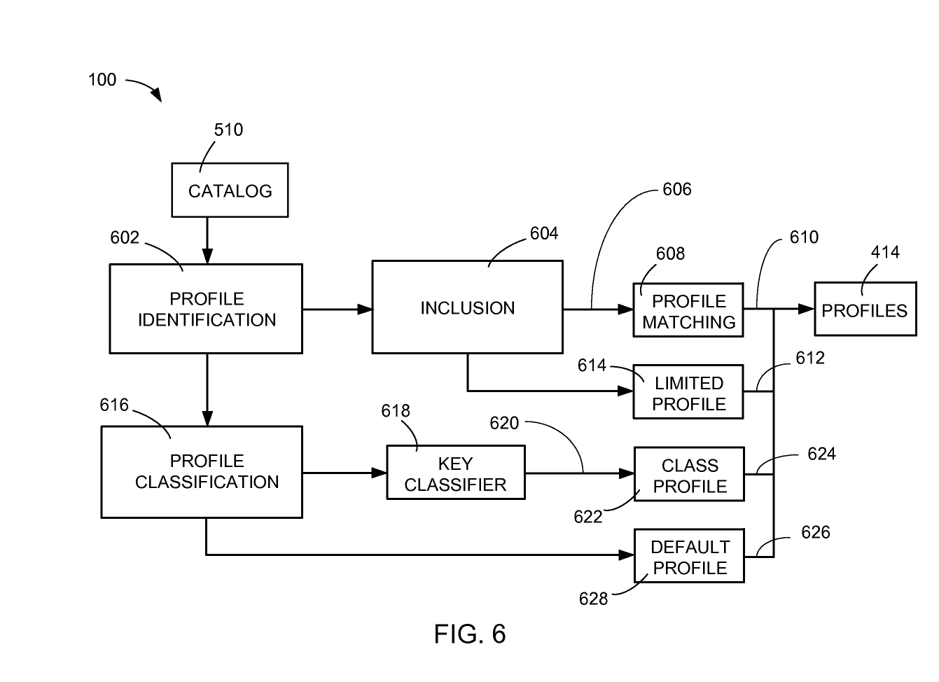

Referring now to FIG. 6, therein is shown a control flow of the content delivery system 100 for profile generation. The content delivery system 100 is shown having the catalog 510. The catalog 510 can include the user identification 412 of FIG. 4 and the user classification 410 of FIG. 4 of the new users 416 of FIG. 4.

A profile identification module 602 can be coupled to the catalog 510 and can examine or gather the access level 422 of FIG. 4 from the content engine module 404 of FIG. 4, the detected device ensemble 420 of FIG. 4 from the device engine module 406 of FIG. 4, and the user identification 412 of the new users 416 contained within the catalog 510. An inclusion module 604 can be coupled to the profile identification module 602.

The inclusion module 604 searches the access level 422 and the detected device ensemble 420 for the user identification 412 of the new users 416 listed in the catalog 510. When the user identification 412 of the new users 416 in the catalog 510 is a required portion 606 of the access level 422 or the device attributes 214 of FIG. 2, the inclusion module 604 can output the required portion 606 to a profile matching module 608.

The profile matching module 608 can be coupled to the inclusion module 604 and can search the profiles 414 of FIG. 4 for any of the profiles 414 containing the required portion 606. The profile matching module 608 can output the profiles 414 containing the required portion 606 of the user identification 412 contained in the catalog 510.

The profile matching module 608 can identify, by the process above, the profiles 414 that contain the user identification 412 specifically or the profiles 414 that matches a superset of the required portion 606. When the user identification 412 of the new users 416 is contained in one of the profiles 414 the new users 416 is assigned a matched profile 610 in the profile matching module 608. When the user identification 412 of the new users 416 is not contained within one of the profiles 414 the new users 416 will be assigned a limited profile 612 in a limited profile module 614 coupled to the inclusion module 604.

The profile identification module 602 can also be coupled to a profile classification module 616 and can examine or gather the access level 422 from the content engine module 404, the device attributes 214 from the device engine module 406, and the user classification 410 of the new users 416 contained within the catalog 510. A key classifier module 618 can be coupled to the profile classification module 616.

The key classifier module 618 searches the access level 422 and the device attributes 214 for the user classification 410 of the new users 416 listed in the catalog 510. When the user classification 410 of the new users 416 in the catalog 510 is contained within the access level 422 and the device attributes 214, the key classifier module 618 will search for a classifying characteristic 620 that is contained in the user classification 410 for both the detected device ensemble 420 and the access level 422. The classifying characteristic 620 contained in both the access level 422 and the device attributes 214 can be output to a class profile module 622.

The class profile module 622 can assign the new users 416 to a class profile 624 containing the classifying characteristic 620 of the new users 416. The class profile module 622 can search the profiles 414 for any of the profiles 414 containing the classifying characteristic 620. All of the profiles 414 containing the classifying characteristic 620 can be output as a class profile 624. When the profile classification module 616 detects that there is no classification associated with the new users 416 in the catalog 510, the new users 416 will then be assigned a default profile 626 in a default profile module 628 coupled to the profile classification module 616.

The profiles 414 can be a compilation of all the new users 416 and the users 408 of FIG. 4 from the profile matching module 608, the limited profile module 614, the class profile module 622, the default profile module 628, or a combination thereof. The catalog 510 and the profiles 414 can be contained within the first storage unit 314 of FIG. 3 or the second storage unit 346 of FIG. 3.

Further the required portion 606, the limited profile module 614, and the classifying characteristic 620 can be stored within the first storage unit 314 and the second storage unit 346. The profile identification module 602, the inclusion module 604, the profile classification module 616, and the key classifier module 618 can all be run on either the first control unit 312 of FIG. 3, the second control unit 334 of FIG. 3, or can be run on a combination of the first control unit 312 and the second control unit 334 and transferred over the communication path 104 of FIG. 1.

The profile matching module 608, the limited profile module 614, and the class profile module 622 can be operated on or a part of the identification engine module 402 of FIG. 4. The profile matching module 608, the limited profile module 614, and the class profile module 622 can be the first software 326 of FIG. 3 in the first storage unit 314 and run on the first control unit 312. The profile matching module 608, the limited profile module 614, and the class profile module 622 can also be the second software 342 of FIG. 3 on the second storage unit 346 and run on either the second control unit 334 or the first control unit 312.

The profile identification module 602 and the profile classification module 616 can collect the access level 422 and the first device ensemble 202 of FIG. 2 from the first device 102 of FIG. 1. The profile identification module 602 and the profile classification module 616 can also collect the access level 422 and the second device ensemble 418 of FIG. 4 from the second devices 106 of FIG. 1. The profile identification module 602 and the profile classification module 616 can utilize the communication path 104 to transfer the access level 422 and the first device ensemble 202 or the second device ensemble 418.

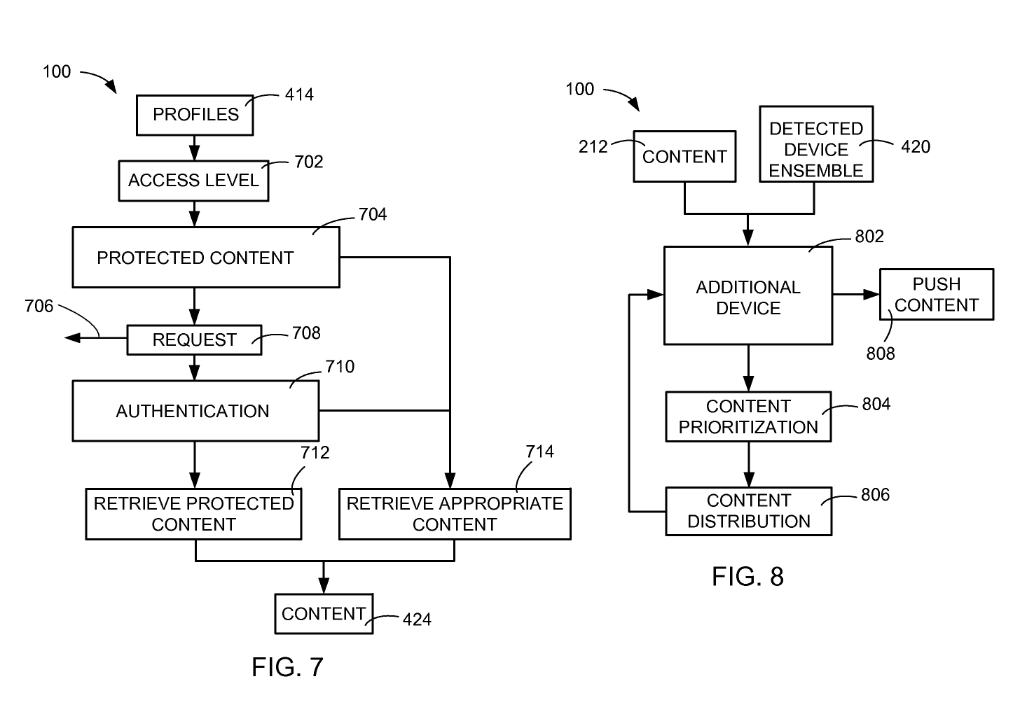

Referring now to FIG. 7, therein is shown a control flow of the content delivery system 100 for access assessment. The content delivery system 100 is shown having the profiles 414 coupled to an access level module 702.

The access level module 702 can compare the profiles 414 required by the access level 422 of FIG. 4 with the profiles 414 of the users 408 of FIG. 4. When the access level 422 requires the profiles 414 of the users 408, the access level module 702 determines that the profiles 414 of the users 408 meets or exceeds the access level 422. When the access level 422 requires the profiles 414 that the users 408 does not have the access level module 702 determines that the profiles 414 of the users 408 does not meet the access level 422.

The access level module 702 can be coupled to a protected content module 704. The protected content module 704 searches the content 212 of FIG. 2 or the device attributes 214 of FIG. 2 for the access level 422. When the access level 422 is found in the content 212 or the device attributes 214 then the protected content module 704 can determine that the content 212 that is being requested by the users 408 or the new users 416 of FIG. 4 is protected by the access level 422.

When the protected content module 704 determines that the content 212 that is being requested is protected a request 706 for further authentication can be made in a request module 708. The request module 708 can request further information from the identification engine module 402 of FIG. 4.

The request module 708 can be coupled to an authentication decision module 710. The authentication decision module 710 can include inputs of the user identification 412 of FIG. 4 from the identification engine module 402. The authentication decision module 710 can compare the user identification 412 with the access level 422. When the user identification 412 of the users 408 is contained within the access level 422, the authentication decision module 710 determines whether the users 408 meet the access level 422 required for viewing the content 212 protected by the access level 422.

When the access level 422 requires the user identification 412 that the users 408 does not possess, the authentication decision module 710 determines that the users 408 does not meet the access level 422 required to view the content 212. When the user identification 412 of the users 408 meets the access level 422 of the content 212 that is restricted, then a retrieve protected content module 712 can retrieve the content 212 and allow the users 408 to have access to the content 212 that is protected.

When the protected content module 704 searches the content 212 for the access level 422 and the access level 422 is not found within the content 212 or associated with the content 212 in the content engine module 404 of FIG. 4, the protected content module 704 can determine that the content 212 that is being requested by the users 408 is not protected by the access level 422. When the content 212 is not protected by the access level 422, the content 212 can be retrieved in a retrieve appropriate content module 714.

In a similar manner, when the authentication decision module 710 determines that the identification engine module 402 cannot authenticate the users 408 by providing the user identification 412 required by the access level 422, the retrieve appropriate content module 714 will allow the users 408 to view the content 212 that is not protected. The content 212 can contain any protected content that was retrieved by the retrieve protected content module 712 and any of the content 212 retrieved by the retrieve appropriate content module 714.

The access level module 702, the protected content module 704, the request module 708, the authentication decision module 710, and the retrieve protected content module 712 can be operated within or can be a portion of the content engine module 404 and coupled to the identification engine module 402 and the device engine module 406 of FIG. 4. The access level module 702, the protected content module 704, the request module 708, the authentication decision module 710, and the retrieve protected content module 712 can be operated can also be operated on or run within the first control unit 312 of FIG. 3 of the first device 102 of FIG. 1 or the second control unit 334 of FIG. 3 of the second devices 106 of FIG. 1 and coupled through the communication path 104 of FIG. 1.

The access level module 702, the protected content module 704, the request module 708, the authentication decision module 710, and the retrieve protected content module 712 can be operated can be coupled together internally to the first control unit 312 or the second control unit 334 or can be coupled through the communication path 104. The profiles 414 can be stored within the first storage unit 314 of FIG. 3 or the second storage unit 346 of FIG. 3 and can be retrieved by the access level module 702 through the first storage interface 324 of FIG. 3 or the second storage interface 348 of FIG. 3.

Referring now to FIG. 8, therein is shown a control flow of the content delivery system 100 for customization. The content delivery system 100 is shown having the content 212 and the detected device ensemble 420 coupled to an additional device module 802.

The additional device module 802 reads the detected device ensemble 420 using code that compares a current state of the detected device ensemble 420 with a previous state of the detected device ensemble 420 to detect any change in the detected device ensemble 420. When the additional device module 802 detects a change in the detected device ensemble 420, the additional device module 802 further inspects the change within the detected device ensemble 420.

When the detected device ensemble 420 includes a change that indicates that one of the second devices 106 of FIG. 1 has been detected, the additional device module 802 can alert a content prioritization module 804 coupled to the additional device module 802. The content prioritization module 804 can prioritize the order and type of the content 212 for display on the first device 102 of FIG. 1 or the second devices 106 that were detected in the additional device module 802.

Further, when the second devices 106 are detected a content distribution module 806 coupled to the additional device module 802 can determine the optimal distribution of the content 212 between the first device 102 and the second devices 106. When the second devices 106 are no longer being added and the content 212 has been prioritized and distributed by the content prioritization module 804 and the content distribution module 806, a push content module 808 coupled to the additional device module 802 can provide the content 212 for display to the first device 102 and the second devices 106.

The additional device module 802, the content prioritization module 804, the content distribution module 806, and the push content module 808 can be another control flow for or be a portion of the content engine module 404 and operated on the first control unit 312 of FIG. 3 or the second control unit 334 of FIG. 3. The content 212 can reside on the content engine module 404 in the first storage unit 314 of FIG. 3 or the second storage unit 346 of FIG. 3 and coupled to the content engine module 404 with the communication path 104. The detected device ensemble 420 can reside on the device engine module 406 of FIG. 4 in the first storage unit 314 or the second storage unit 346 and coupled to the content engine module 404 with the communication path 104.

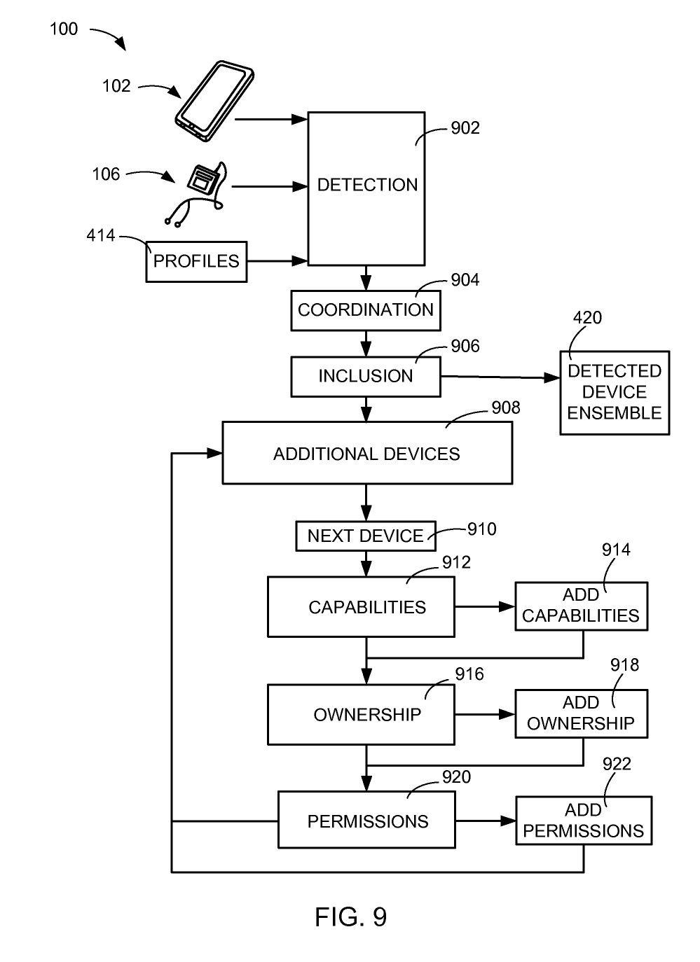

Referring now to FIG. 9, therein is shown a control flow of the content delivery system 100 for ensemble generation. The content delivery system 100 is shown having the profiles 414 and the first device 102, and the second devices 106 interfacing with a detection module 902. The detection module 902 can interface with the first device 102 or the second devices 106 to determine when the first device 102 is or the second devices 106 are present within the environment that the detection module 902 can detect.

A coordination module 904 coupled to the detection module 902 reads the device attributes 214 of FIG. 2 and the detected device ensemble 420 for the first device 102 and the second devices 106. The device attributes 214 and the first device ensemble 202 of FIG. 2 for the first device 102 and the device attributes 214 and the second device ensemble 418 of FIG. 4 for the second devices 106 are compared and contrasted. The similarities and differences in the device attributes 214 and the first device ensemble 202 and the second device ensemble 418 correspond to the extent and ability of the first device 102 and the second devices 106 to work together to display the content 212 of FIG. 2.

The coordination module 904 can determine the optimal method of display by isolating the device attributes 214 and the first device ensemble 202 with the best capabilities from the first device 102 and the device attributes 214 and the second device ensemble 418 with the best capabilities from the second devices 106. The coordination module 904 can utilize the device attributes 214 and the first device ensemble 202 with the best capabilities from the first device 102 and the device attributes 214 and the second device ensemble 418 with the best capabilities from the second devices 106 to display images, project sounds and meet any other needs of the users 408 of FIG. 4 or the new users 416 of FIG. 4 based on the profiles 414 of the users 408 or the new users 416.

An inclusion module 906 can be coupled to the coordination module 904 and can include the output of the coordination module 904 into the detected device ensemble 420 for both the first device 102 and the second devices 106 in combination. The inclusion module 906 can incorporate the device attributes 214 and the first device ensemble 202 with the best capabilities from the first device 102 and the device attributes 214 and the second device ensemble 418 with the best capabilities from the second devices 106 individually, in combination, or partially (like allowing the first device 102 to only providing audio while another one of the second devices 106 provides video), to provide a digital media experience to the users 408 or the new users 416.

The inclusion module 906 can be coupled to an additional device module 908. The additional device module 908 interface with the first device 102 and the second devices 106 at regular intervals and compare the current reading with a previous reading to determine when more of the second devices 106 are newly added to the environment that the additional device module 908 can detect.

When more of the second devices 106 are detected as being newly attached or within the area detectable by the additional device module 908, a next device module 910 coupled to the additional device module 908 can inspect more of the second devices 106 in sequential order.

The next device module 910 can be coupled to a capabilities module 912 that can determine the second device ensemble 418 of the second devices 106 that are newly added including any capabilities. If the capabilities module 912 can ascertain the second device ensemble 418 of the second devices 106 that have been newly added, the second device ensemble 418 for the second devices 106 that have been newly added is included with the detected device ensemble 420 for all of the second devices 106 and the first device 102 that can be detected in an add capabilities module 914.

The capabilities module 912 and the add capabilities module 914 are coupled to an ownership module 916. The ownership module 916 reads the device attributes 214 of the second devices 106 that have been newly added. When the ownership module 916 detects the device attributes 214 that include an owner listed among the users 408, the device attributes 214 for the second devices 106 that have been newly added is added to the device attributes 214 for all the second devices 106 and the first device 102 that can be detected in an add ownership module 918.

The ownership module 916 and the add ownership module 918 are coupled to a permissions module 920. The permissions module 920 reads the device attributes 214 of the second devices 106 that have been newly added. When the permissions module 920 detects the device attributes 214 that include a permission, the device attributes 214 including the permission can be added to the device attributes 214 for all the second devices 106 and the first device 102 that can be detected in an add permissions module 922.

The permissions module 920 and the add permissions module 922 are coupled to the additional device module 908 and will analyze each one of the second devices 106 until all of the second devices 106 are accounted for and the second device ensemble 418 from the capabilities module 912, the device attributes 214 from the ownership module 916, and the device attributes 214 from the permissions module 920 are incorporated into the detected device ensemble 420 and the device attributes 214 for all the second devices 106 and the first device 102 that can be detected.

The detection module 902, the coordination module 904, the inclusion module 906, the additional device module 908, the next device module 910, the capabilities module 912, the ownership module 916, and the permissions module 920 can operate within or be a portion of the device engine module 406 of FIG. 4 and can be operated in the first control unit 312 of FIG. 3 or the second control unit 334 of FIG. 3 and coupled through the communication path 104.

The first device ensemble 202, the second device ensemble 418, and the device attributes 214 can be detected from the first storage unit 314 of FIG. 3 or the second storage unit 346 of FIG. 3 for the respective devices. The first device ensemble 202 can correspond to the first user interface 318 of FIG. 3, the first communication unit 316 of FIG. 3, the first control unit 312, the location unit 320 of FIG. 3, or the first storage unit 314. The device attributes 214 for the first device 102 can be contained within the first storage unit 314. The device attributes 214 for the second devices 106 can be contained within the second storage unit 346.

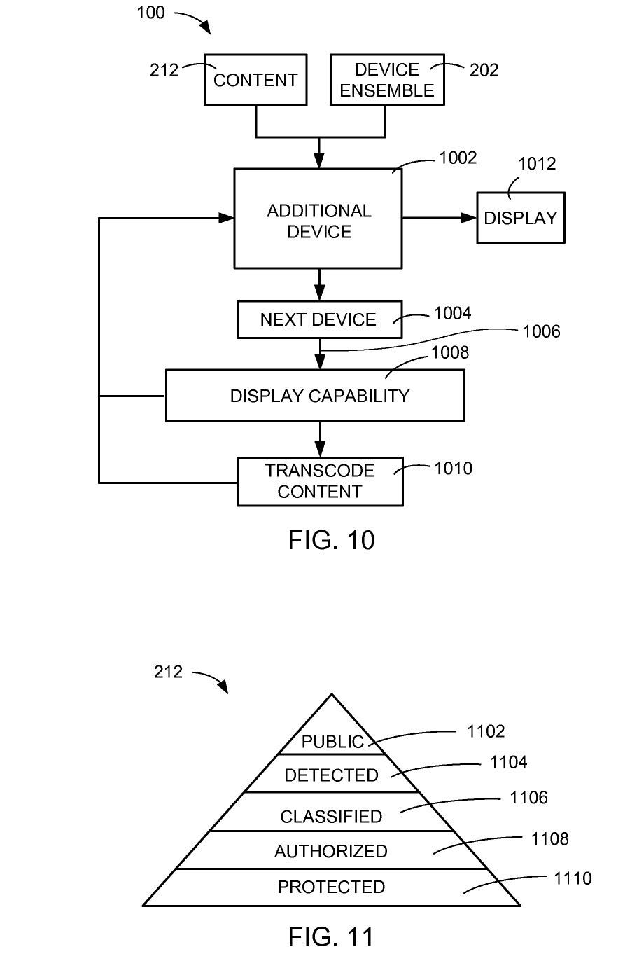

Referring now to FIG. 10, therein is shown a control flow of the content delivery system 100 for capability combining. The content delivery system 100 is shown having the content 212 and the detected device ensemble 420 coupled to an additional device module 1002.

The additional device module 1002 can interface with the second devices 106 of FIG. 1 at regular intervals and compare the current reading with a previous reading to determine when the second devices 106 are newly added to the environment that the additional device module 1002 can detect. In this way, the additional device module 1002 can detect if one of the second devices 106 have been newly added to the environment of the content delivery system 100.

When one of the second devices 106 have been newly added, a next device module 1004, coupled to the additional device module 1002 can inspect the second devices 106 to determine display characteristics 1006 of the second devices 106.

The next device module 1004 can be coupled to a display capability module 1008. The display capability module 1008 compares the display characteristics 1006 to the content 212. When the content 212 is not the right format or is too large or too small of a file size, the content 212 cannot be displayed.

When the content 212 has a format and size that fall below the display characteristics 1006 the content 212 can be displayed. When the content 212 cannot be displayed from the second devices 106 or the first device 102 of FIG. 1 based on the display characteristics 1006, the content 212 can be transcoded in a transcode content module 1010.

When the content 212 is capable of being displayed on the second devices 106 or the first device 102 or if the content 212 has been transcoded in the transcode content module 1010 the additional device module 1002 will determine whether there are more of the second devices 106. Transcoded is defined as modified to allow display or reproduction of the content 212. If there are no more of the second devices 106 then the device engine module 406 of FIG. 4 will display the content 212 on the second devices 106 or the first device 102 in a display module 1012.

The additional device module 1002, the next device module 1004, the display capability module 1008, and the display module 1012 can function within or be a portion of the device engine module 406 and can operate within the first control unit 312 of FIG. 3 of the first device 102 or the second control unit 334 of FIG. 3 of the second devices 106 and coupled through the communication path 104. The display characteristics 1006 can be stored within the first storage unit 314 of FIG. 3 or the second storage unit 346 of FIG. 3 and compared to the content 212 within the first control unit 312 or the second control unit 334.

Referring now to FIG. 11, therein is shown a security model of the content 212 of FIG. 2. The content 212 is shown having various security levels for various parts of the content 212 that can determine how or what portion of the content 212 is provided for display to the first device 102 of FIG. 1 or the second devices 106 of FIG. 1.

The content 212 can be depicted as having restrictions in a pyramid structure with the smallest restrictions on the content 212 at the top and the most restrictions or security measures on the bottom. The fewest restrictions on the content 212 are the portions that belong to a public classification 1102 of the content 212. The public classification 1102 of the content 212 is available to everyone and the content 212 can be displayed even when no single one of the users 408 of FIG. 4 is present within the area of the first device 102 displaying the content 212.

The public classification 1102 can be less restrictive than a detected classification 904. The detected classification 1104 can allow access to the content 212 only if the users 408 are present. The detected classification 1104 can be less restrictive than a classified portion 1106 of the content 212. The classified portion 1106 can allow access to the content 212 only if the users 408 are classified.

The users 408 can be considered classified when the users 408 are grouped according to their perceived characteristics. The classified portion 1106 can allow access to certain groups of the users 408 and deny access to other groups based on the extent of the protection in the classified portion 1106. The classified portion 1106 can include an authorized classification 1108. The authorized classification 1108 can allow access to the content 212 if the users 408 are classified and belong to the authorized classification 1108. The content engine module 404 of FIG. 4 can provide the content 212 or restrict access to the content 212 to when the profiles 414 of FIG. 4 meet or exceed the authorized classification 1108.

The authorized classification 1108 can be less restive than a protected classification 910. The protected classification 1110 can allow access to the content 212 only if the users 408 are uniquely identified.

As an illustrative example if the users 408 include three young children, one of which is uniquely identified; the content delivery system 100 of FIG. 1 will consider that the permissions of the uniquely identified one of the users 408 will be subjugated to the two non-identified children. The first device 102 might be the television 112 of FIG. 1 and can then display two guest boxes captioned “Guest” next to a box with the uniquely identified and captioned one of the users 408.

The television 112 can provide the content 212 such as games or movies that are “parent approved”, or in other words, the users 408 meet only the classified portion 1106 level of the content 212 since they are classified but are not authorized to view the authorized classification 908. Further, since the users 408 are classified the classified portion 1106 of the content 212 can also include the content belonging to one of the users 408 with the user identification 412, and can further suggest other content that can be of interest to the users 408.

As another illustrative example if the users 408 include two parents and one young child, all of which are uniquely identified, the content delivery system 100 will consider that the permissions of any one of the users 408 will be subjugated to the group classification as a “family”. The first device 102 might be the television 112 and can then display one box with a picture of the family caption with “Hello, Smith Family”.

The television 112 can provide the content 212 such as games or movies that are “family friendly”, or in other words, the family of the users 408 only meet only the classified portion 1106 level of the content 212 even though the two parents are authorized to watch mature content or belong to a more restrictive classification, however, the parents can override the classified portion 1106 restriction if in their judgment they felt it might be appropriate. Further, since the users 408 are all uniquely identified, the content 212 can also include the content belonging to any one of the users 408 and can suggest other content that can be of interest to the users 408.

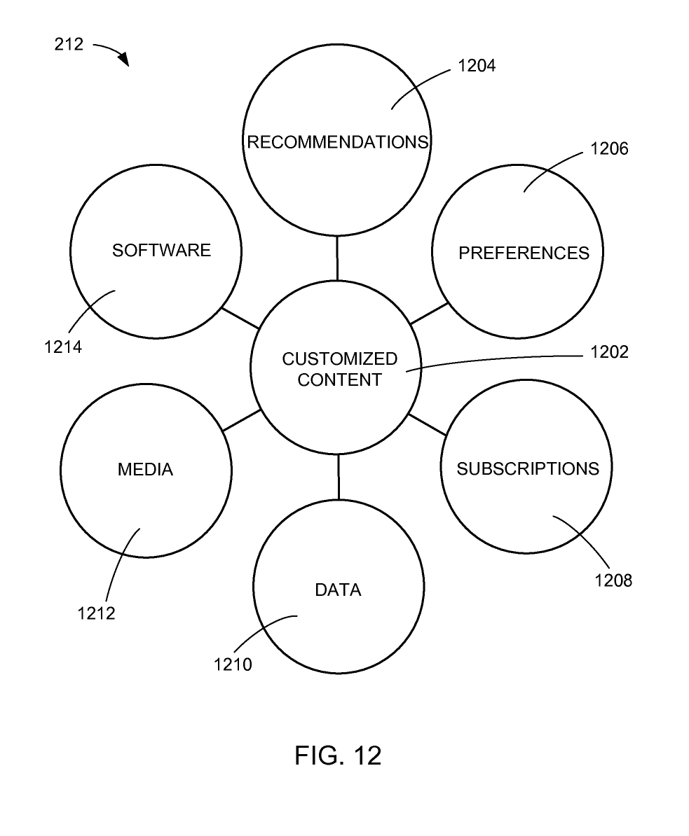

Referring now to FIG. 12, therein is shown a customization map of the content 212 of FIG. 2. The content 212 is shown having a portion of customized content 1202 surrounded by other types of the content 212 that can be included into the customized content 1202 to suit and aid the users 408 of FIG. 4.

The customized content 1202 can include recommendations 1204 to other parts of the content 212 that the users 408 will probably find useable or enjoyable. The customized content 1202 can also factor in preferences 1206 of the users 408, include subscriptions 1208 of the users 408, data 1210 of the users 408, media 1212 that the users 408 enjoys, and software 1214 used by the users 408.

Access to all the diversified types of the content 212 provides an interactive, dynamic, and effective way to utilize the customized content 1202. As an illustrative example, the users 408 can include one of the users 408 having a preferred piece of the content 212 on the first device 102 of FIG. 1, such as a game or interactive movie. The first device 102 can simply be tapped to the corner of one of the second devices 106 of FIG. 1 to indicate a connection and transfer should be made. If the content protections are met the users 408 can enjoy the content 212 on the second devices 106 together.

As another illustrative example, one of the new users 416 of FIG. 4 can be a sick child taken to the doctor's office. The doctor can provide the first device 102 that might be a medical monitoring device for blood oxygen content or temperature. The content engine module 404 of FIG. 4 can provide different content to the users 408 who can include the doctor and the child's parents. One of the users 408 can select the application that will be used to monitor the first device 102 by selecting it on one of the second devices 106 and sending the application to the second devices 106 of the users 408.

The users 408 can receive the application with a pop up note identifying the sender and a method of acknowledging the application. This can state “Dr. Williams has sent you an application . . . Accept”. The display of the content 212 of the application can be different for each of the second devices 106 such as a game of taking a temperature, a line chart for reading the temperature, or a more detailed analysis of the temperature in a spreadsheet based on the profiles 414 of FIG. 4 of the users 408.

The content delivery system 100 of FIG. 1 results in movement of the users 408 in the physical world when the identification engine module 402 of FIG. 4 changes the profiles 414 based on the new users 416 requiring the users 408 to interact with the first device 102. As the movement in the physical world occurs, the movement itself creates additional information that is converted back to the profiles 414 for the continued operation of the content delivery system 100 and to continue the movement in the physical world.

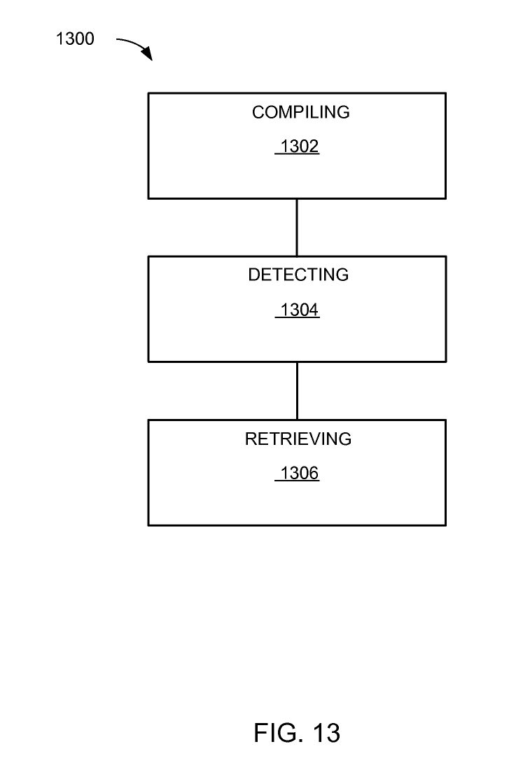

Referring now to FIG. 13, therein is shown a flow chart of a method 1300 of operation of the content delivery system in a further embodiment of the present invention. The method 1300 includes: compiling a detected device ensemble in a block 1302; detecting user information to develop a profile in a block 1304; and retrieving a content with an access level matching the profile and displayable with the detected device ensemble for displaying on a device in a block 1306.

Thus, it has been discovered that the content delivery system 100 and identification mechanism of the present invention furnishes important and heretofore unknown and unavailable solutions, capabilities, and functional aspects for content delivery systems. The resulting processes and configurations are straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a content delivery system comprising:
compiling a detected device ensemble;
detecting user information to develop a profile; and
retrieving a content with an access level matching the profile and compatible with the detected device ensemble for displaying on a device.

2. The method as claimed in claim 1 further comprising providing the content for displaying on the device when the user information indicates a user is present.

3. The method as claimed in claim 1 wherein retrieving the content includes restricting the content based on the profile for identifying a new user.

4. The method as claimed in claim 1 further comprising detecting a device attribute identifying a device ownership for displaying on the device.

5. The method as claimed in claim 1 further comprising detecting unique identifiers to develop a user identification for accessing the content.

6. A method of operation of a content delivery system comprising:
compiling a detected device ensemble;
detecting user information to develop a profile including a user identification or a user classification;
retrieving a content with an access level matching the user identification or the user classification, and the content compatible with the detected device ensemble or transcoded for the detected device ensemble for displaying on a device.

7. The method as claimed in claim 6 wherein retrieving the content includes retrieving the content compatible with a second device ensemble or transcoded for the second device ensemble.

8. The method as claimed in claim 6 further comprising providing the content for displaying on the device when the access level is overridden.

9. The method as claimed in claim 6 wherein compiling the detected device ensemble includes combining a first device ensemble and a second device ensemble to create the detected device ensemble.

10. The method as claimed in claim 6 further comprising providing the content for displaying on the device when the profile is an authorized classification.

11. A content delivery system comprising:
a device engine module for compiling a detected device ensemble;
an identification engine module, coupled to the device engine module, for detecting user information to develop a profile; and
a content engine module, coupled to the device engine module, for retrieving a content with an access level matching the profile and compatible with the detected device ensemble.

12. The system as claimed in claim 11 wherein the content engine module is for providing the content when the user information indicates a user is present.

13. The system as claimed in claim 11 wherein the content engine module is for restricting the content based on the profile identifying a new user.

14. The system as claimed in claim 11 wherein the device engine module is for detecting a device attribute identifying a device ownership for displaying on a device.

15. The system as claimed in claim 11 further an comprising identification module for detecting unique identifiers to develop a user identification for accessing the content.

16. The system as claimed in claim 11 wherein:
the identification engine module is for imparting a user identification or a user classification to develop the profile; and
the content engine module is for retrieving the content based on the user identification or the user classification, and the content compatible with the detected device ensemble or transcoded for the detected device ensemble.

17. The system as claimed in claim 16 wherein the content engine module is for retrieving the content compatible with a second device ensemble or transcoded for the second device ensemble.

18. The system as claimed in claim 16 wherein the content engine module is for providing the content for displaying on a device when the access level is overridden.

19. The system as claimed in claim 16 wherein the device engine module is for combining a first device ensemble and a second device ensemble to create the detected device ensemble.

20. The system as claimed in claim 16 wherein the content engine module is for providing the content for displaying on a device when the profile is an authorized classification.
